(19) United States
(12) Patent Application Publication
(10) Pub. No.: US 2006/0115797 A1
(43) Pub. Date: Jun. 1, 2006

(54) Bar codes or radio frequency identification tags on paper currency, checks, credit/debit cards and personal identification

(76) Inventor: Stuart Franklin Gray, Baltimore, MD (US)

Correspondence Address: STUART F. GRAY, 5221 SPRINGLAKE WAY, BALTIMORE, MD, 21212, US

(21) Appl. No.: 10/751,618

(22) Filed: Jan. 6, 2004

(51) Int. Cl. G09B 19/18

(52) U.S. Cl. 434/110

(57) ABSTRACT

Paper currency and/or checks and/or credit cards and/or debit cards and/or personal identification with one or more bar codes or radio frequency identification (RFID) tags, either of which acts as a unique identifier, to assist in counting, sorting and tracking said item and to act as a deterrent to counterfeiting activities. A method for tracking said items including the steps of creating a clearinghouse to manage one or more databases, attaching a bar code and/or RFID tag to said items, scanning the said items, transmitting key information to the clearinghouse, then receiving approval or rejection of the transaction from the clearinghouse.

### BACKGROUND

1. Field of Invention

This invention relates to placing one or more bar codes and/or one or more radio frequency identification (RFID) tags on paper currency, personal checks, corporate checks, bank checks, payroll checks, credit cards, debit cards, birth certificates, student ID's, social security cards, driver's licenses, visas, passports and airport/train/bus baggage. This invention also relates to a method for tracking these items, a method for reducing counterfeit transactions, a method for safeguarding travel and a method for reducing lost and stolen baggage.

1. Description of Prior Art

The United States government prints its existing paper currency using expensive paper stock and intricate patterns of unique designs and colors. Each paper currency has a serial number that consists of two alphabet letters followed by eight numbers followed by one alphabet letter. These serial numbers are printed in two places on the front of the paper currency. For example, one such number could be AA12345678A. This invention would seek to replace said serial numbers with unique bar codes and/or RFID tags. The other prior inventions—the embedded plastic security thread, the watermark and the color-shifting ink—would also be replaced.

Checks have bar codes that are used to identify bank accounts, and checks have individual check numbers. The check numbers are not part of the bar code. This invention would seek to replace said bar codes and check numbers with unique bar codes and/or RFID tags for each check.

Credit cards and debit cards have magnetic stripes. This invention would seek to replace said magnetic stripes with unique bar codes or bar codes and RFID tags for each credit card. Solely using RFID tags are already being tested on credit cards and are not therefore part of this invention.

Forms of personal identification such as birth certificates, student ID's, social security cards, driver's licenses, visas and passports commonly use numbers for identification. This invention would replace said numbers with unique bar codes and/or RFID tags for each form of personal identification.

Airport baggage have bar coded tags that identify the bag by its scheduled flight. This invention would replace said bar coded baggage tags with unique bar codes and/or RFID tags for each piece of baggage.

RFID tags are either active or passive, and their capabilities are generally known as discussed in U.S. application Ser. No. 09/050,623 filed Mar. 30, 1998.

### OBJECTS AND ADVANTAGES

Bar codes and RFID tags are easier to scan, track and keep a log of each transaction by date, time, location and other critical information. Bar code readers can more quickly scan a bar code than existing serial number readers can scan a serial number. Furthermore, bar code scanners are more accurate than clerks who manually key punch information. RFID antennae can more quickly scan multiple RFID tags than bar code readers can scan a single bar code. RFID antennae are also accurate. Beside these advantages of speed and accuracy, there are other advantages in cost, scalability, globalization, ease of use, convenience and ecology. Further advantages will become evident from the following new processes for counting paper currency, sorting paper currency, and tracking the flow of paper currency from one transaction point to the next.

Paper currency with bar codes and/or RFID tags is easier to count and sort. Imagine a bar code reader machine that can quickly sort paper currency and count it based on reading the bar code. Imagine a radio frequency antennae machine that can count a bag full of paper currency without looking inside the bag. Imagine counting the paper currency with multiple currencies inside the bag as well. The speed of sorting and counting paper currency for banks and retail stores will improve significantly. By comparison, existing techniques are slow, labor intensive, costly and sometimes inaccurate.

Paper currency with bar codes and/or RFID tags is easier to track. Assume you are buying a $20 gift certificate from a retail store. Under the proposed new process for tracking paper currency transactions, you would hand the store owner a $20 bill plus your personal identification (personal ID). Under this scenario, assume that all paper currency has one or more bar codes and/or one or more RFID tags, and that your personal ID (driver's license or other ID card) has one or more bar codes and/or one or more RFID tags. The store owner would scan your personal ID and then scan the paper currency. This information would be stored in a unique transaction file (with paper currency ID, date, time, location and personal ID) and then transmitted via the internet or other secured communication link to a national and/or global clearinghouse (“clearinghouse”) that keeps a record of all such transactions.

The clearinghouse would match the person as last known owner of the paper currency and/or search for counterfeit or duplicate bar codes or RFID tags. This could be a global clearinghouse searching for duplicate bar codes or RFID tags on multiple currencies. If the person wasn't the last known owner and/or a counterfeit or duplicate bar code or RFID tag is found, the store owner would be instructed to stamp “counterfeit” on the bill and return it to the person. That person must then go to a local counterfeit currency office to exchange the “counterfeit” currency for another $20 bill. The duplicate match (or “twin”) would be flagged as “counterfeit” as well and the next time it is used in a transaction, it would be rejected under the sane process, stamped as “counterfeit” and that person instructed to go to their local bank for a $20 bill exchange. At the end of each day or week, all banks would mail “counterfeit” paper currency to the clearinghouse. In the clearinghouse, the two “twins” would be examined and the one true counterfeit bill would be identified and the log of all transactions for that bill would be investigated further (all previous transactions by date, time, location and person were previously recorded). Once counterfeiters know counterfeit currency can be traced, it should significantly reduce counterfeit activities.

In addition, the clearinghouse would verify the personal ID was active and not counterfeit. If it had been inactive or counterfeit, the store owner would stamp “counterfeit” on the personal ID and return it to the person. If the personal ID is OK and the currency is OK, the clearinghouse would transmit its approval to the store owner. In a different scenario, if the same person was buying a $15 gift certificate with a $20 bill, the store owner would scan the person's identification again and scan the $5 bill given as change. This transaction file (with paper currency ID, date, time, location and personal ID) would also be stored in the clearinghouse. This way the U.S. government can keep a record of all paper currency transactions and their owners coming into and going out of all retail stores and banks.

How might this be helpful if the store is robbed? The clearinghouse has a record of all paper currency at the store. Match that record against what is left after the robbery and the U. S. government can put a flag on all the paper currency that was stolen. As soon as that money appears in circulation again, it can be used to track the robber by their personal identification. How might this be helpful if a bank is robbed? The same process would work for the bank as for the retail store. How might this be helpful if an individual is robbed? The same process would work for the individual as for the retail store and the bank. Once robbers know they will get caught, there should be a significant reduction in robberies.

What if I lose my money? Money that is found can only be used by the last “recorded” owner (in this case me). Whoever found the money would not have a preceding record of having been given the money from a bank or retail store. They could only turn in the money to a bank “lost and found”, and this money would be returned to its owner. So if you lose your money, you should feel confident it will be returned.

How can I give money to my children or to friends? This can be done in any bank or retail store. The bank or retail store scans my personal ID and scans the paper currency (as if I were buying something), then scans my child's or friend's personal ID and scans the paper currency again. The clearinghouse successfully records the transfer.

Periodically, the U.S. government will want to take damaged bills out of circulation. The government will do this by removing the bar code and/or RFID tag from the clearinghouse file. All new bills will have a unique bar code and/or RFID tag.

Although the examples above are specific, these should not be construed as limiting the scope of this invention. For example, there could be multiple clearinghouses (one in each Federal Reserve District that could back-up each other) linked together via a secured communication link. The secured communication link could be the internet or any other secure data link including but not limited to POTS lines, ISDN lines, frame relay, point-to-point T1 lines or VPN. Also, the scanning procedure could vary such as scan the currency and then scan the personal identification and/or possibly scan the store identification too. The transaction file might keep more or less information than the paper currency ID, date, time, location and personal ID. With bar codes and/or RFID tags, paper currency can be printed on plain paper thus eliminating the high expense of printing on special paper, using the embedded plastic security thread, the watermark and the color-shifting ink. All of this technology exists today and can be developed if this invention is accepted.

Personal checks, bank checks, corporate checks and payroll checks are subject to counterfeit activity. Counterfeit checks are a big problem today. U.S. banks reported 10,000 check fraud incidents last year, a fivefold increase since 1996. The problem appears to be growing due to advances in computer capabilities. Many of the necessary counterfeit supplies can be purchased in local office-supply stores. As a result, businesses and individuals lose tens of millions of dollars each year. Banks have responded to corporate check fraud with Positive Pay, a service that can reduce check fraud. Under Positive Pay, corporations transmit their check issue information including check number, check amount, and “payable to” to their bank. Then, before a check is cleared, the bank matches these items to the information transmitted by the company. If there is not a perfect match to the check issue information or if a duplicate check is presented, the bank will reject the fraudulent check.

If checks had unique bar codes and/or RFID tags, the process for identifying fraudulent checks would be simpler. Imagine having a clearinghouse that contains the check issue information for all checks. People and corporations would transmit this information to the clearinghouse. When a check is presented to a bank lock box or to a bank teller, they would scan the bar code and/or RFID tag for the check and scan the presenter's personal identification. This information along with the date, time and location of the bar code/RFID reader would be transmitted to the national clearinghouse. If this information matches the check issue information and the personal ID is active and not counterfeit, the lock box or teller is granted approval. If the information does not match, the lock box or teller is told to stamp “counterfeit” on the check. With a simpler counterfeit check identification process, the fraud could be identified earlier at the lock box or teller's window. This would make it easier to catch check counterfeiters. If counterfeiters knew they would get caught, it would significantly reduce the problem.

Software can be developed for personal computers that would print the unique bar codes on checks and capture the Positive Pay information, which would be transmitted over the internet or other secure communication link to the clearinghouse. With bar codes, checks can be printed on plain computer paper thus eliminating the high expense of buying special check paper. All of this technology exists today and can be developed if this invention is accepted.

People are having their personal identities stolen every day. This leads to significant credit problems for these individuals are well as financial losses. Imagine if we had a national clearinghouse for personal ID's similar to the clearinghouses that exist for credit cards. Fraudulent ID's would be hard to obtain. Only approved sites (motor vehicle administrations, social security offices, hospitals, etc.) could transmit personal ID issue information to the clearinghouse and attach a unique bar code and/or RFID tag to the ID. If you lose your driver's license (or birth certificate, student ID, passport, visa, social security card), you could have it de-activated immediately with one call to the clearinghouse. This invention envisions placing unique bar codes and/or RFID tags on these forms of personal identification so that it is easier to scan the person's identity. A scan takes less than a second. If a clerk had to type in the identification number, it could take 10-15 seconds, and there might be typing errors. All of this technology exists today and can be developed if this invention is accepted.

Imagine how transportation safety could be improved if we had a clearinghouse for airline flights, train trips, bus trips, car rentals and truck rentals. At check-in, the counter person could scan the person's identification and transmit that information along with the date, time and location of the scan to the clearinghouse. If the personal ID is not fraudulent, the transaction is approved. To get through security clearance, they simply need to scan their identification. To get aboard the airplane, train or bus, they simply need to scan their identification. Security clearance and gate check-ins would be faster. Checked baggage could have unique bar code and/or RFID tags. As bags are checked-in, a transaction file could be sent to the clearinghouse that includes the person's identification and each bag that is checked. At baggage claim, the person's identification is scanned and each bag is scanned with it. The opportunity for lost or stolen bags would be significantly reduced. All of this technology exists today and can be developed if this invention is accepted.

There are many more examples that could be given to support the advantages of this invention. The scope of this invention should be determined by the appended claims and their legal equivalents, rather than by the examples given.

### DRAWING FIGURES

FIG. 1 shows a possible location for the bar code 1 and/or RFID tag 2 on the front or back of the paper currency. The bar code could have 15 characters. The first three characters could be reserved for country code. For example, 001 could designate the U.S. The next four characters could be the dollar value. For example, 0020 could designate a $20 bill. The last eight characters would be unique to that country code and dollar value. For example, 001002000000001 would be the first US $20 bill and 001002000000002 would be the second US $20 bill. With 15 characters arranged in this order, there are 99,999,999 unique paper money currencies for each country code and each denomination. Certain countries such as the U.S. may need two or more country codes, thereby multiplying the number of unique paper money currencies by denomination. For example, two country codes would equal 99,999,999 times two or 199,999,998 unique paper money currencies in that denomination.

FIG. 2 shows a possible location for the bar code 3 and/or RFID tag 4 on the front or back of personal checks, corporate checks, bank checks or payroll checks.

FIG. 3 shows a possible location for the bar code 5 and/or RFID tag 6 on the front or back of credit cards or debit cards.

FIG. 4 shows a possible location for the bar code 7 and/or RFID tag 8 on the front or back of personal identification such as birth certificates, student ID's, social security cards, driver's licenses, visas and passports.

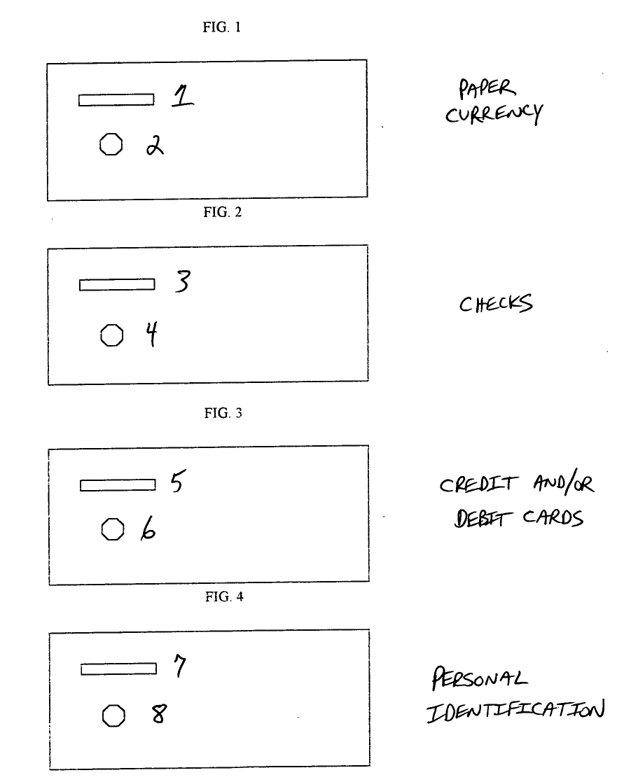

It is possible to have one or two bar codes and/or an RFID tag on the front and/or back of each of the above items. For example, one bar code and one RFID tag may be best since it combines the least expensive bar code technology (perhaps preferred by small retail stores) with the most advanced radio frequency technology (perhaps preferred by banks, large retailers and airports).

Although the figures above are specific, these should not be construed as limiting the scope of the invention. For example, the bar code could have more or less characters and a single RFID tag could suffice.

The scope of the invention should be determined by the appended claims and their legal equivalents, rather than by the figures given.

I claim:

1. On paper currency with one or more bar codes and/or one or more radio frequency identification (RFID) tags, the improvement wherein said bar codes or RFID tags will declare the amount of said paper currency and/or the country of origin;

2. The improvement where claim 1 will significantly reduce the time it takes to count paper currency and improve the accuracy of counting paper currency;

3. The improvement where claim 1 will significantly reduce the time it takes to sort paper currency and improve the accuracy of sorting paper currency;

4. On paper currency with one or more bar codes and/or one or more radio frequency identification (RFID) tags, the improvement wherein said bar codes or RFID tags will declare a unique assigned number that cannot be duplicated or counterfeited without detection of such on said paper currency;

5. The improvement where claim 4 will be a more reliable means for identifying counterfeit paper currency and will significantly reduce counterfeit paper currency;

6. The improvement where claim 4 will permit the exchange of paper currency to be traced thereby helping track the source of counterfeit paper currency (this applies to all currencies through a global clearinghouse as well) and helping track lost or stolen paper currency;

7. The improvement where claim 4 will cost less to manufacture than current paper currency using expensive paper stock and color patterns to deter counterfeit paper currency;

8. A method for tracking paper currency and/or personal checks and/or corporate checks and/or bank checks and/or payroll checks and/or credit cards and/or debit cards and/or birth certificates and/or student ID's and/or social security cards and/or driver's licenses and/or visas and/or passports and/or airport baggage and/or train baggage and/or bus baggage, including the steps of:
Building a national and/or global clearinghouse to manage a database for certain transaction files;
Putting one or more bar codes and/or one or more radio frequency identification (RFID) tags on the paper currency and/or personal checks and/or corporate checks and/or bank checks and/or payroll checks and/or credit cards and/or debit cards and/or birth certificates and/or student ID's and/or social security cards and/or driver's licenses and/or visas and/or passports and/or airport baggage and/or train baggage and/or bus baggage;
Scanning the paper currency and/or personal checks and/or corporate checks and/or bank checks and/or payroll checks and/or credit cards and/or debit cards and/or birth certificates and/or student ID's and/or social security cards and/or driver's licenses and/or visas and/or passports and/or airport baggage and/or train baggage and/or bus baggage into a transaction file;
Transmitting said transaction file via the internet or any secure communication link to the clearinghouse; and
Receiving approval or rejection of said transaction from the clearinghouse.

9. The improvement where claim 8 reduces counterfeit items including paper currency and/or personal checks and/or corporate checks and/or bank checks and/or payroll checks and/or credit cards and/or debit cards and/or birth certificates and/or student ID's and/or social security cards and/or driver's licenses and/or visas and/or passports.

10. The improvement where claim 8 increases the safety of airline, train or bus travel, or car rental or truck rental.

11. The improvement where claim 8 reduces lost and/or stolen baggage at airports and/or train stations and/or bus terminals.
